(19) United States
(12) Patent Application Publication
(10) Pub. No.: US 2021/0402598 A1
(43) Pub. Date: Dec. 30, 2021

(54) ROBOT CONTROL DEVICE, ROBOT CONTROL METHOD, AND ROBOT CONTROL PROGRAM

(71) Applicant: SONY CORPORATION, Tokyo (JP)

(72) Inventors: Ryo TERASAWA, Tokyo (JP); Yuki ITOTANI, Tokyo (JP); Kiyokazu MIYAZAWA, Kanagawa (JP); Tetsuya NARITA, Tokyo (JP); Yasuhiro MATSUDA, Tokyo (JP); Toshimitsu KAI, Tokyo (JP)

(73) Assignee: SONY CORPORATION, Tokyo (JP)

(21) Appl. No.: 17/281,495

(22) PCT Filed: Sep. 4, 2019
(86) PCT No.: PCT/JP2019/034722

§ 371 Date: Mar. 30, 2021

(30) Foreign Application Priority Data
Oct. 10, 2018 (JP) 2018-191997

(51) Int. Cl. B25J 9/16; B25J 19/02

(52) U.S. Cl. CPC B25J 9/1664; B25J 19/023; B25J 9/1612; B25J 9/163

(57) ABSTRACT

A robot device (10) acquires object information related to an object to be gripped by the robot device including a grip unit (32) that grips an object. The robot device (10) then determines, based on operation contents executed by the robot device with the object gripped and the object information, a constraint condition when the operation contents are executed.

### FIELD

The present disclosure relates to a robot control device, a robot control method, and a robot control program.

### BACKGROUND

When a motion trajectory of a robot including an arm capable of gripping an object is planned, a user imposes a constraint condition on a task executed by the robot. Furthermore, a method of determining a unique constraint condition in a case where a specific task is detected is also known. For example, a method is known in which, when the robot grips a cup containing liquid, the cup is inclined slightly to automatically detect that the liquid is contained, and the container is controlled to be maintained in a horizontal state for transportation. This technique determines the constraint condition in the specific task of transporting the cup containing liquid. Note that, as a motion planning algorithm that plans a motion trajectory in consideration of a constraint condition, “Task Constrained Motion Planning in Robot Joint Space, Mike Stilman, IROS 2007” is known.

### CITATION LIST

### Patent Literature

Patent Literature 1: JP 2007-260838 A

### SUMMARY

### Technical Problem

However, in the above-described conventional technique, since a user designates a constraint condition in advance according to a task, excess or deficiency of the constraint condition is likely to occur, and as a result, it is difficult to plan an accurate motion trajectory. Furthermore, the method of determining a unique constraint condition for a specific task cannot be applied to different tasks, and lacks versatility.

Therefore, the present disclosure proposes a robot control device, a robot control method, and a robot control program that can improve the accuracy of a planned motion trajectory.

### Solution to Problem

According to the present disclosure, a robot control device includes an acquisition unit that acquires object information related to an object to be gripped by a robot device including a grip unit that grips an object, and a determination unit that determines, based on operation contents executed by the robot device with the object gripped and the object information, a constraint condition when the operation contents are executed.

### BRIEF DESCRIPTION OF DRAWINGS

FIG. 1 is a diagram for describing a robot device according to a first embodiment.

FIG. 2 is a functional block diagram illustrating a functional configuration of the robot device according to the first embodiment.

FIG. 3 is a diagram illustrating an example of task information stored in a task DB.

FIG. 4 is a diagram illustrating an example of constraint information stored in a constraint condition DB.

FIG. 5 is a flowchart illustrating a flow of execution processing of a trajectory plan.

FIG. 6 is a diagram for describing supervised learning of a constraint condition.

FIG. 7 is a diagram for describing an example of a neural network.

FIG. 8 is a diagram for describing reinforcement learning of the constraint condition.

FIG. 9 is a configuration diagram of hardware that implements functions of the robot device.

### DESCRIPTION OF EMBODIMENTS

Hereinafter, embodiments of the present disclosure will be described in detail with reference to the drawings. Note that, in each of the following embodiments, the same parts are designated by the same reference signs, so that duplicate description will be omitted.

### 1. First Embodiment

### [1-1. Description of Robot Device According to First Embodiment]

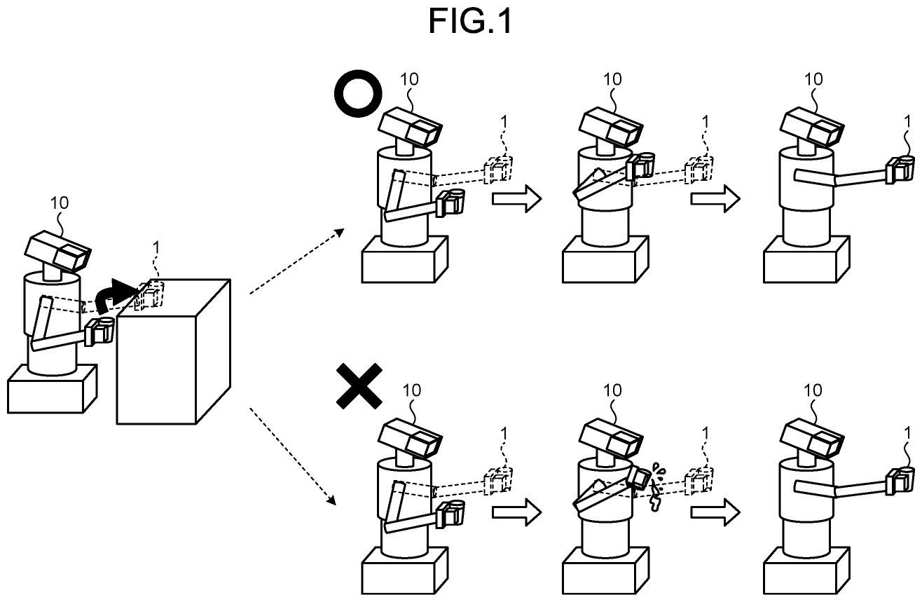

FIG. 1 is a diagram for describing a robot device 10 according to a first embodiment. The robot device 10 illustrated in FIG. 1 is an example of a robot device including an arm capable of holding an object, and executes movement, arm operation, gripping of the object, and the like according to a planned motion trajectory.

The robot device 10 uses task information related to a task that defines operation contents or an action of the robot device 10 and object information related to a gripped object, to autonomously determine a constraint condition when the robot device 10 executes the task. The robot device 10 then plans the motion trajectory according to which the robot device 10 operates in compliance with the constraint condition, and the robot operates according to the planned motion trajectory, so that the task can be executed.

For example, as illustrated in FIG. 1, a case where a cup containing water is moved and put on a desk will be described as an example. When gripping the cup, the robot device 10 acquires, as the task information, “putting the object to be gripped on the desk”, and acquires, as the object information, image information or the like of the “cup containing water”. In this case, the robot device 10 specifies, as the constraint condition, “keeping the cup horizontal so as not to spill the water” from the task information and the object information. After that, the robot device 10 uses a known motion planning algorithm to plan a motion trajectory for implementing a task “moving the cup containing water and putting the cup on the desk” while observing this constraint condition. In the robot device 10, the robot device 10 then operates the arm, an end effector, or the like according to the motion trajectory, moves the cup to be held so as not to spill the water, and puts the cup on the desk.

As described above, the robot device 10 can determine the constraint condition by using the task information and the object information, and plan the motion trajectory using the determined constraint condition, and thus the constraint condition can be determined without excess or deficiency, and the accuracy of the planned motion trajectory can be improved.

[1-2. Functional Configuration of Robot Device According to First Embodiment]

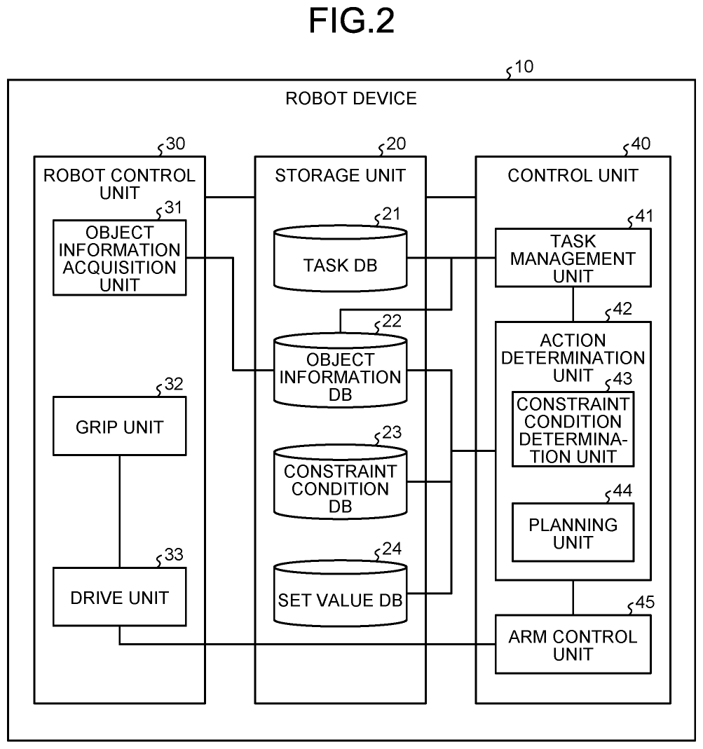

FIG. 2 is a functional block diagram illustrating a functional configuration of the robot device 10 according to the first embodiment. As illustrated in FIG. 2, the robot device 10 includes a storage unit 20, a robot control unit 30, and a control unit 40.

The storage unit 20 is an example of a storage device that stores various data, a program or the like executed by the control unit 40 or the like, and is, for example, a memory, a hard disk, or the like. The storage unit 20 stores a task DB 21, an object information DB 22, a constraint condition DB 23, and a set value DB 24.

The task DB 21 is an example of a database that stores each task. Specifically, the task DB 21 stores information related to tasks set by a user. For example, in the task DB 21, it is possible to set highly abstract processing contents such as “carrying” or “putting”, and it is also possible to set specific processing contents such as “carrying the cup containing water” or “reaching to the object to be gripped”.

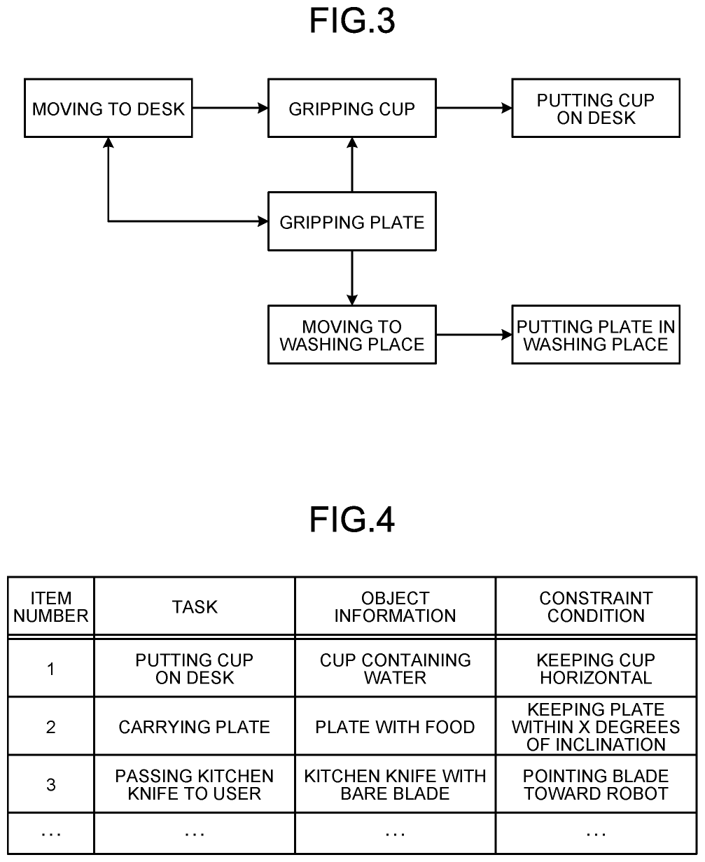

In addition, the task DB 21 can also store the task information in the form of a state transition that sets what action should be taken next according to the environment and the current task by using a state machine or the like. FIG. 3 is a diagram illustrating an example of the task information stored in the task DB 21. As illustrated in FIG. 3, the task DB 21 holds each piece of the task information in the state transition. Specifically, the task DB 21 stores information that transitions from a task “moving to the desk” via a task “gripping the cup” to a task “putting the cup on the desk”, information that transitions from the task “moving to the desk” via a task “holding a plate” to the task “gripping the cup”, information that transitions from the task “moving to the desk” via the task “gripping the plate” and a task “moving to a washing place” to a task “putting the plate in the washing place”, and the like.

The object information DB 22 is an example of a database that stores information related to the gripped object indicating an object to be gripped or an object being gripped. For example, the object information DB 22 stores various information such as image data acquired by an object information acquisition unit 31 of the robot control unit 30, which will be described later.

The constraint condition DB 23 is an example of a database that stores constraint conditions which are conditions for achieving purposes imposed on objects when tasks are executed. Specifically, the constraint condition DB 23 stores constraint conditions specified by use of the task information and the object information. FIG. 4 is a diagram illustrating an example of the constraint information stored in the constraint condition DB 23. As illustrated in FIG. 4, the constraint condition DB 23 stores “item numbers, the task information, the object information, and the constraint conditions” in association with each other.

The “item numbers” stored here are information for identifying the constraint conditions. The “task information” is information related to tasks that define processing contents of the robot device 10, and is, for example, each piece of the task information stored in FIG. 3. The “object information” is each piece of the object information stored in the object information DB 22. The “constraint conditions” are specified constraint conditions.

In the example of FIG. 4, it is indicated that, in a case where the task information is “putting the cup on the desk” and the object information is the “cup containing water”, “keeping the cup horizontal” is specified as the constraint condition. Furthermore, it is indicated that, in a case where the task information is “carrying the plate” and the object information is the “plate with food”, “keeping the plate within X degrees of inclination” is specified as the constraint condition. Furthermore, it is indicated that, in a case where the task information is “passing a kitchen knife to the user” and the object information is the “kitchen knife with a bare blade”, “pointing the blade toward the robot” is specified as the constraint condition.

Note that the constraint condition can also be set by a threshold value. For example, instead of simply “constraining posture around a z-axis”, it is possible to set “suppressing deviation of posture around the z-axis within five degrees”, and it is also possible to set a threshold value indicating a limit value of an angle of the arm, a threshold value indicating a limit value of an angle of the end effector, or the like. With such a setting, it is possible to strengthen and weaken the constraint condition. Since the strength of the constraint condition affects a robot mechanism and the motion planning algorithm, the threshold value is appropriately set according to the mechanism and algorithm to which the constraint condition is applied, so that it is possible to improve the accuracy of the planned motion trajectory, such as making it possible to solve at a higher speed or guaranteeing existence of a solution. Furthermore, as will be described later, the constraint condition can also be learned by learning processing or the like.

Although the above-described example of the constraint condition is described specifically for the sake of explanation, the constraint condition can also be defined with a description format that is common to each task and does not depend on the task. As the common description format, a tool coordinate system and a world coordinate system can be used. To explain with the above-described specific example, in the case of “keeping the cup containing water horizontal”, the constraint condition can be “constraining posture of a z-axis of the tool coordinate system in a z-axis direction of the world coordinate system”. Furthermore, in the case of “keeping the plate with food within X degrees of inclination”, the constraint condition can be “constraining posture of the z-axis of the tool coordinate system in the z-axis direction of the world coordinate system within an error range of X degrees”. In addition, in the case of “pointing the blade toward the robot”, the constraint condition can be “constraining posture of an x-axis of the tool coordinate system in a −x-axis direction of the world coordinate system”. If such a description format is adopted, it is possible to directly set the constraint condition in the motion planning algorithm, and even in a case of learning using a neural network, which will be described later, an output label does not depend on the task, which enables learning on the same network.

Furthermore, it is also possible to store the specific constraint conditions illustrated in FIG. 4 when the robot device 10 operates, and to convert specific constraint conditions as correct answer labels into a common format of constraint conditions at the time of the learning using the neural network to input the constraint conditions to the neural network. At this time, the robot device 10 can also convert specific constraint conditions into a common format of constraint conditions by preparing a common format or the like in advance. Therefore, even if the user registers learning data (teaching data) without being aware of the common format or the like, the robot device 10 can automatically convert the learning data into the common format and then input the learning data to the neural network for learning, and thus a burden on the user can be reduced.

Note that the normal tool coordinate system when nothing is gripped matches coordinates of the end effector, but in a case where a tool such as a cup, a plate, or a kitchen knife is gripped, a tool tip is the tool coordinate system. Furthermore, in the above-described world coordinate system, a front direction of the robot device 10 is an x-axis, a left direction of the robot device 10 is a y-axis, and a vertically upward direction is the z-axis. In addition, the tool coordinate system of the kitchen knife can use coordinates that match the world coordinate system when the kitchen knife has an orientation of actually cutting (when the blade faces forward and is horizontal). Therefore, pointing the x-axis of the tool coordinate system of the kitchen knife toward the −x direction of the world coordinates corresponds to pointing the blade toward the robot.

The set value DB 24 is an example of a database that stores initial values, target values, and the like used for planning the motion trajectory. Specifically, the set value DB 24 stores a position of a hand, a position and posture of a joint, and the like. For example, the set value DB 24 stores, as the initial values, a joint angle indicating the current state of the robot, the position and posture of the hand, and the like. In addition, the set value DB 24 stores, as the target values, a position of the object, a target position and posture of the hand of the robot, a target joint angle of the robot, and the like. Note that, as various position information, various information used in robot control, such as coordinates, can be adopted, for example.

The robot control unit 30 includes the object information acquisition unit 31, a grip unit 32, and a drive unit 33, and is a processing unit that controls the robot mechanism of the robot device 10. For example, the robot control unit 30 can be implemented by an electronic circuit such as a microcomputer or a processor, or a process of the processor.

The object information acquisition unit 31 is a processing unit that acquires the object information related to the gripped object. For example, the object information acquisition unit 31 acquires the object information by use of a visual sensor that captures images with a camera or the like, a force sensor that detects forces and moments on a wrist portion of the robot, a tactile sensor that detects the presence or absence of contact with the object, the thickness, or the like, a temperature sensor that detects the temperature, or the like. The object information acquisition unit 31 then stores the acquired object information in the object information DB 22.

For example, the object information acquisition unit 31 uses the visual sensor to capture an image of the cup, which is the gripped object, and stores, as the object information, the image data obtained by the image capture in the object information DB 22. Note that, when image processing is performed on the image data of the cup acquired by the visual sensor, a feature amount of the object (cup), such as the area, center of gravity, length, and position, and a state such as “the cup contains water” can be extracted. Furthermore, the object information acquisition unit 31 can also use, as the object information, sensor information obtained by actively moving the arm based on the task information.

The grip unit 32 is a processing unit that grips the object, such as the end effector, for example. For example, the grip unit 32 is driven by the drive unit 33, which will be described later, to grip the object to be gripped.

The drive unit 33 is a processing unit that drives the grip unit 32, such as an actuator, for example. For example, the drive unit 33 drives the arm (not illustrated) or the grip unit 32 of the robot according to the planned motion trajectory based on an instruction or the like from an arm control unit 45, which will be described later.

The control unit 40 includes a task management unit 41, an action determination unit 42, and the arm control unit 45, and is a processing unit that plans the motion trajectory or the like of the robot device 10, such as a processor, for example. Furthermore, the task management unit 41, the action determination unit 42, and the arm control unit 45 are examples of an electronic circuit such as a processor, examples of a process executed by the processor, or the like.

The task management unit 41 is a processing unit that manages the tasks of the robot device 10. Specifically, the task management unit 41 acquires the task information designated by the user and the task information stored in the task DB 21, and outputs the task information to the action determination unit 42. For example, the task management unit 41 refers to the task information in FIG. 3, causes the task state to transition to the next state by using the current task status, the environment of the robot device 10, and the like, and acquires a corresponding piece of the task information.

More specifically, the task management unit 41 specifies, as the next task, “putting the cup on the desk” in a case where the current state of the robot device 10 corresponds to “gripping the cup”. The task management unit 41 then outputs, as the task information, “putting the cup on the desk” to the action determination unit 42.

The action determination unit 42 includes a constraint condition determination unit 43 and a planning unit 44, and is a processing unit that generates a trajectory plan in consideration of the constraint condition.

The constraint condition determination unit 43 is a processing unit that determines the constraint condition by using the task information and the object information. Specifically, the constraint condition determination unit 43 refers to the constraint condition DB 23, and acquires a constraint condition corresponding to a combination of the task information input from the task management unit 41 and the object information acquired by the object information acquisition unit 31. The constraint condition determination unit 43 then outputs the acquired constraint condition to the planning unit 44.

For example, when acquiring the task information “putting the cup on the desk” and the object information “image data in which the cup contains water”, the constraint condition determination unit 43 specifies the constraint condition “keeping the cup horizontal” from the constraint condition list illustrated in FIG. 4. At this time, the constraint condition determination unit 43 can also decide whether or not the constraint condition can be set. For example, in a case where it can be confirmed from the object information that the cup does not contain water, the constraint condition determination unit 43 does not set the constraint condition because it is not necessary to keep the cup horizontal. That is, the constraint condition determination unit 43 can determine that it is necessary to set the constraint condition “keeping the cup horizontal” if the cup contains water, but it is not particularly necessary to set the constraint condition if the cup does not contain water. As described above, in the above-described example of the cup, since “carrying the cup” is known as the task information, it is known that it is sufficient to determine whether or not the cup contains water. Therefore, the constraint condition determination unit 43 confirms, by image processing, whether or not the cup contains water from the object information (image data) to determine the constraint condition. As described above, the constraint condition determination unit 43 combines the task information and the object information to determine the constraint condition.

Note that the constraint condition determination unit 43 can acquire, for the object information, the latest information stored in the object information DB 22. In addition, in a case where the cup is already gripped, the object information acquisition unit 31 captures an image of the state of the grip unit 32 to save the image. However, the constraint condition determination unit 43 can also store not only the image data of the gripping state but also image data obtained at the stage before trying to grip the object to be gripped, to use the image data as the object information.

The planning unit 44 is a processing unit that plans the motion trajectory of the robot device 10 for executing the task while observing the constraint condition determined by the constraint condition determination unit 43. For example, the planning unit 44 acquires the initial value, the target value, and the like from the set value DB 24. Furthermore, the planning unit 44 acquires the task information from the task management unit 41, and acquires the constraint condition from the constraint condition determination unit 43. The planning unit 44 then inputs the acquired various information and constraint condition to the motion planning algorithm to plan the motion trajectory.

After that, the planning unit 44 stores the generated motion trajectory in the storage unit 20 or outputs the generated motion trajectory to the arm control unit 45. Note that, in a case where there is no constraint condition, the planning unit 44 plans the motion trajectory without using the constraint condition. Furthermore, as the motion planning algorithm, various known algorithms such as “Task Constrained Motion Planning in Robot Joint Space, Mike Stilman, IROS 2007” can be used.

The arm control unit 45 is a processing unit that operates the robot device 10 according to the motion trajectory planned by the planning unit 44 to execute the task. For example, the arm control unit 45 controls the drive unit 33 according to the motion trajectory to execute, with respect to the cup gripped by the grip unit 32, the task “putting the cup on the desk” while observing the constraint condition “keeping the cup horizontal”. As a result, the arm control unit 45 can execute the operation of putting the cup gripped by the grip unit 32 on the desk so as not to spill the water contained in the cup gripped by the grip unit 32.

[1-3. Flow of Processing of Robot Device According to First Embodiment]

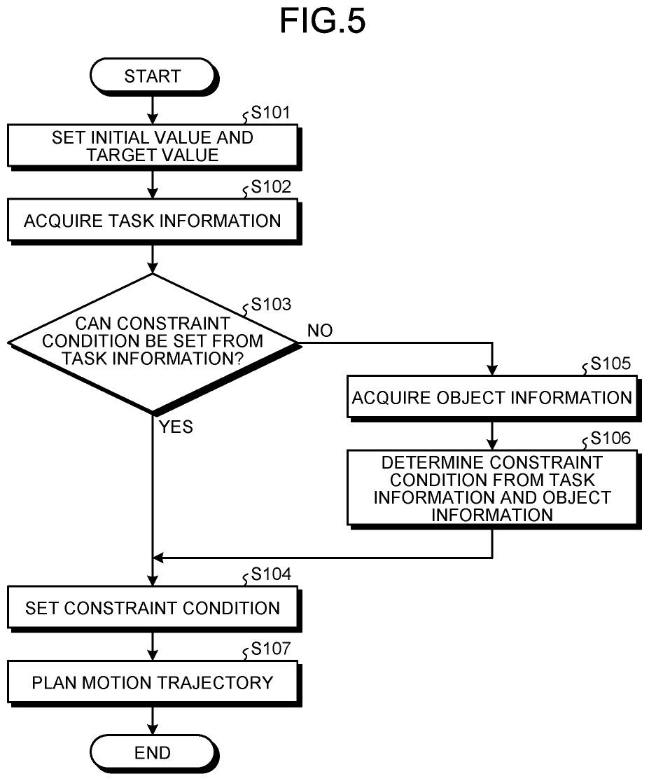

FIG. 5 is a flowchart illustrating a flow of execution processing of the trajectory plan. As illustrated in FIG. 5, the task management unit 41 sets an initial value and a target value of a motion plan given by a user or the like, analysis of image data, or the like (S101). The information set here is the information stored in the set value DB 24, and is the information used when the orbital motion of the robot device 10 is planned.

Subsequently, the constraint condition determination unit 43 acquires, from the task DB 21, task information corresponding to a task to be executed (S102). The constraint condition determination unit 43 then decides, from the task information, whether or not the constraint condition can be set (S103).

Here, in a case where it is decided from the task information that the constraint condition can be set (S103: Yes), the constraint condition determination unit 43 sets the constraint condition of the motion trajectory (S104). For example, in a case of executing the task of “carrying the cup containing water”, the constraint condition determination unit 43 can set the constraint condition of keeping the cup horizontal so as not to spill the water in the cup currently held. Furthermore, in a case of executing the task of “reaching to the object to be gripped”, the constraint condition is unnecessary if it is known as the task information that nothing is currently gripped, and the constraint condition determination unit 43 can set the constraint condition to nothing.

On the other hand, in a case of deciding from the task information that the constraint condition cannot be set (S103: No), the constraint condition determination unit 43 acquires the object information of the gripped object (S105), determines the constraint condition of the motion trajectory by using the task information and the object information (S106), and sets the determined constraint condition (S104). For example, the constraint condition determination unit 43 performs image processing on the image data, which is the object information, specifies whether or not the cup contains water, and sets the constraint condition according to the specified result.

The planning unit 44 then uses a known motion planning algorithm to plan the motion trajectory of the robot device 10 for executing the task while observing the constraint condition determined by the constraint condition determination unit 43 (S107). After that, the arm control unit 45 operates the robot device 10 according to the motion trajectory planned by the planning unit 44 to execute the task.

[1-4. Effect]

As described above, since the robot device 10 can determine the constraint condition of the motion planning algorithm according to the status, the excess or deficiency of the constraint condition is less likely to occur, and a solution of the motion planning algorithm can be efficiently searched for. The robot device 10 can execute, by using the task information and the object information, useful motion generation from a viewpoint of human-robot interaction, such as “moving the arm so as not to point the blade toward a person” in a task “handing a knife” or the like. Furthermore, the robot device 10 does not require the user to set the constraint condition each time according to the task, and can enhance autonomy. Since the robot device 10 determines the constraint condition by also using the task information, the constraint condition can be applied versatilely regardless of a specific task.

Furthermore, the robot device 10 determines the constraint condition including the threshold value so that the constraint condition can be set loosely or strictly, which enables optimal settings according to a mechanism of the robot arm and the motion planning algorithm. For example, in a case where the robot has a high degree of freedom and it is desired to reduce a search space, the constraint condition is set strictly, so that it is possible to efficiently search the motion planning algorithm, and in a case where the robot has a low degree of freedom, the constraint condition is set loosely, so that it is easier to secure the existence of the solution.

### 2. Second Embodiment

Incidentally, in the first embodiment, an example has been described in which the constraint condition is statically held in advance and uniquely determined from the task information and the object information, but the present invention is not limited to this. For example, it is possible to learn to specify the constraint condition by machine learning. Therefore, in a second embodiment, learning using a neural network and reinforcement learning will be described as examples of machine learning of the constraint condition.

[2-1. Description of Learning Using Neural Network]

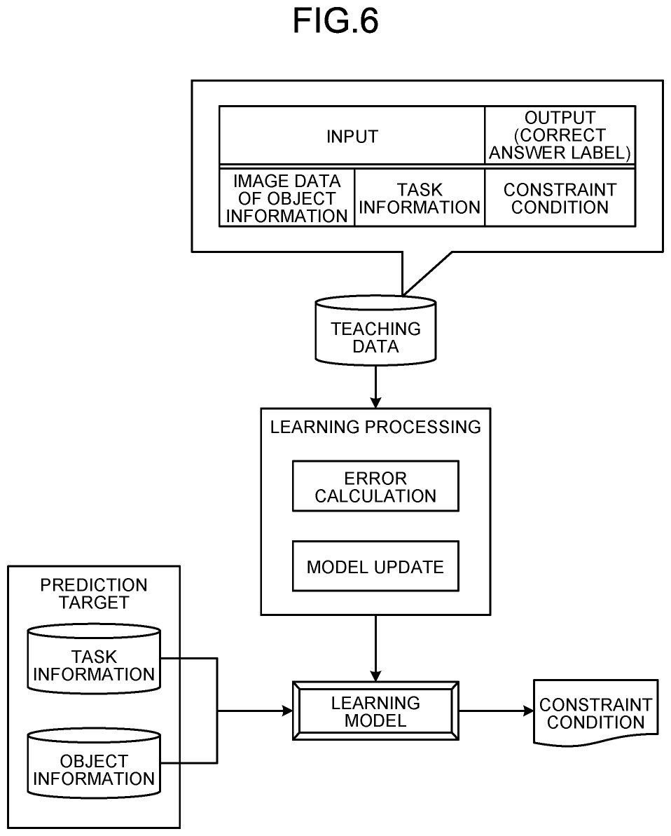

FIG. 6 is a diagram for describing supervised learning of the constraint condition. As illustrated in FIG. 6, the constraint condition determination unit 43 of the robot device 10 holds, as training data, teaching data in which “image data of object information and task information” are set as input data, and the “constraint condition” is set as a correct answer label, which is output data. The constraint condition determination unit 43 then inputs the teaching data to a learning model using the neural network and updates the learning model. Note that a format may be adopted in which the constraint condition is label information and the label information is selected, or a format may be adopted in which a threshold value of the constraint condition is output as a numerical value.

For example, the constraint condition determination unit 43 holds a plurality of pieces of teaching data such as input data “object information (image data of a cup containing water), task information (putting the cup on a desk)” and output data “keeping the cup horizontal”. Note that, as another example of the teaching data, there are input data “object information (image data of a plate with food), task information (putting the plate in a washing place)”, output data “within x degrees of inclination”, and the like.

Note that, here, as an example, the constraint conditions in which specific conditions are described will be exemplified and described, but in the learning of the neural network, as described above, it is preferable to use constraint conditions in a common format using a tool coordinate system and a world coordinate system. As a result, even different constraint conditions of different tasks can be learned on the same network.

The constraint condition determination unit 43 then inputs the input data to the learning model using the neural network, acquires an output result, and calculates an error between the output result and the output data (correct answer label). After that, the constraint condition determination unit 43 updates the model so that the error is minimized by using error back propagation or the like.

As described above, the constraint condition determination unit 43 constructs the learning model by using each piece of the teaching data. After that, the constraint condition determination unit 43 inputs the current “task information” and “object information” for which prediction is performed to the learned learning model, and determines an output result as the constraint condition.

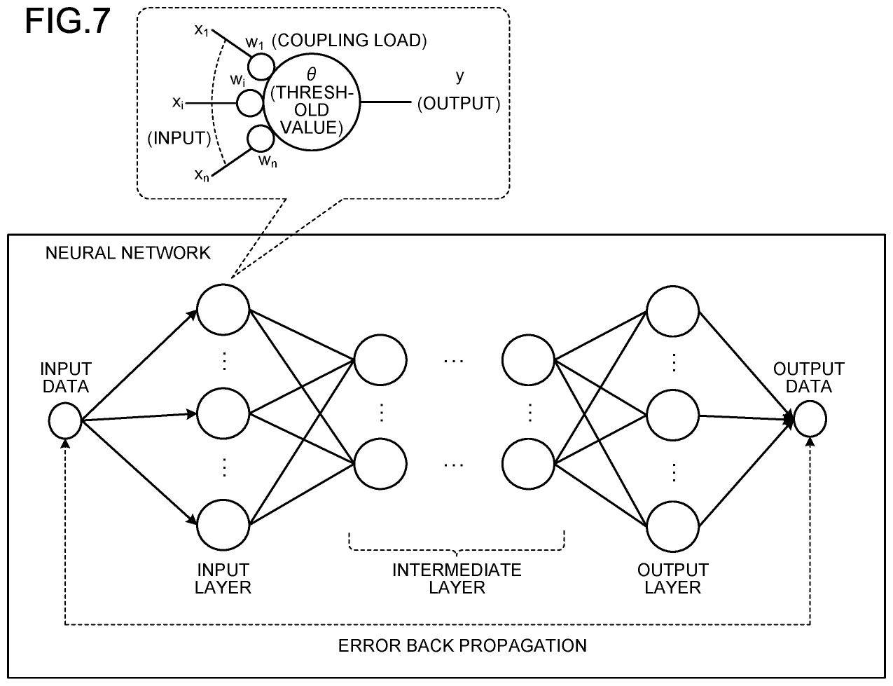

Here, an example of the neural network will be described. FIG. 7 is a diagram for describing an example of the neural network. As illustrated in FIG. 7, the neural network has a multi-stage structure including an input layer, an intermediate layer (hidden layer), and an output layer, and each layer has a structure in which a plurality of nodes is connected by edges. Each layer has a function called “activation function”, each edge has a “weight”, and the value of each node is calculated from the value of a node of a previous layer, the value of the weight of a connection edge (weight coefficient), and the activation function of the layer. Note that, as a calculation method, various known methods can be adopted.

Each of the three layers of such a neural network is configured by combining neurons illustrated in FIG. 7. That is, the neural network includes an arithmetic unit, a memory, and the like that imitate a neuron model as illustrated in FIG. 7. As illustrated in FIG. 7, a neuron outputs an output y for a plurality of inputs x (x₁ to xₙ). The inputs are multiplied by weights w (w₁ to wₙ) corresponding to the inputs x. As a result, the neuron outputs the result y expressed by a formula (1). Note that the inputs x, the result y, and the weights w are all vectors. Furthermore, θ in the formula (1) is a bias, and fₖ is the activation function.

$$y = {f}_{k} ( {\sum }_{i = 1}^{n} {x}_{i} {w}_{i} - θ ) \qquad FORMULA ( 1 )$$

In addition, the learning in the neural network is to modify parameters, that is, weights and biases, so that the output layer has a correct value. In the error backpropagation method, a “loss function” indicating how far the value of the output layer is from a correct state (desired state) is defined for the neural network, and the weights and biases are updated so that the loss function is minimized by use of a steepest descent method or the like. Specifically, an input value is given to the neural network, the neural network calculates a predicted value based on the input value, the predicted value is compared with the teaching data (correct answer value) to evaluate an error, and the value of a coupling load (synaptic coefficient) in the neural network is sequentially modified based on the obtained error, to learn and construct the learning model.

[2-2. Description of Reinforcement Learning]

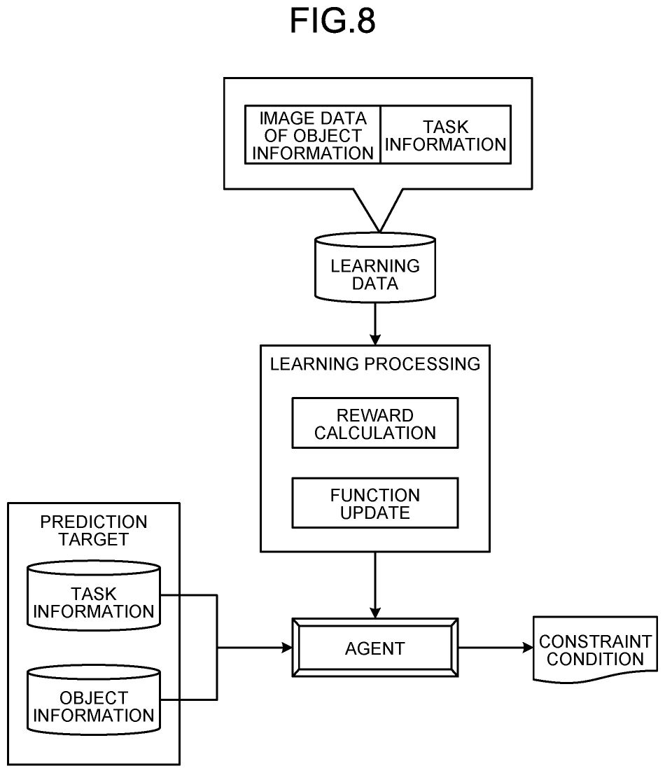

FIG. 8 is a diagram for describing the reinforcement learning of the constraint condition. As illustrated in FIG. 8, the constraint condition determination unit 43 of the robot device 10 holds, as learning data, “image data of object information and task information” and the like. The constraint condition determination unit 43 then inputs the learning data to an agent (for example, the robot device 10), executes a reward calculation according to the result, and updates the function based on the calculated reward to perform learning of the agent. The constraint condition determination unit 43 then uses the trained agent to determine the constraint condition from the task information and the object information for which the prediction is performed.

For example, for the reinforcement learning, Q-learning using an action value function shown in a formula (2) can be used. Here, sₜ and aₜ represent an environment and an action at a time t, and the environment changes to sₜ₊₁ by the action aₜ. rₜ₊₁ indicates a reward that can be obtained by the change of the environment. A term with max is obtained by multiplying, by γ, a Q value in a case where an action a with the highest Q value is selected under the environment sₜ₊₁. Here, γ is a parameter of 0<γ≤1 and is called a discount rate. α is a learning coefficient and is in the range of 0<α≤1. The formula (2) shows that, if an evaluation value Q (sₜ₊₁, mazaₜ₊₁) of the best action in the next environmental state with the action a is larger than an evaluation value Q (sₜ, aₜ) of the action a in the environment s, Q (sₜ, aₜ) is increased, and on the contrary, if the evaluation value Q (sₜ₊₁, mazaₜ₊₁) is smaller than the evaluation value Q (sₜ, aₜ), Q (sₜ, aₜ) is decreased. As described above, the value of the best action in one state propagates to the value of the action in the previous state.

$$Q ( {s}_{t + 1} , {a}_{t + 1} ) ← Q ( {s}_{1} , {a}_{1} ) + α ( {r}_{t + 1} + γ {max}_{a} Q ( {s}_{t + 1} , a ) - Q ( {s}_{t} , {a}_{t} ) ) \qquad FORMULA ( 2 )$$

For example, the state s, the action a, and Q (s, a) indicating “how good the action a in the state s looks” are considered. Q (s, a) is updated in a case where a reward is obtained under a certain condition. For example, in a case where “the cup containing water has been moved with the cup kept horizontal, and the cup has been put on the desk without spilling the water”, the value of Q (carrying the cup containing water, keeping the cup horizontal) is increased. Furthermore, in a case where “the cup containing water has been moved with the cup inclined by Y degrees, and the water has spilled”, the value of Q (carrying the cup containing water, inclining the cup by Y degrees) is decreased. As described above, a randomly selected action is executed, so that the Q value is updated to execute the learning, and an agent that executes the optimal action is constructed.

[2-3. Modified Examples and Effects]

Furthermore, the above-described threshold value can be used as the constraint condition. For setting the threshold value, for example, a learning method can be adopted in which whether the constraint condition is loosened or tightened (according to the mechanism or algorithm) is given as a reward for the reinforcement learning. In addition, the output of the supervised learning can be used as the threshold value. Determining whether or not the constraint condition can be set from the task information in S103 in FIG. 5 can also be performed by various machine learning such as supervised learning in which an image is input.

### 3. Other Embodiments

The processing according to each of the above-described embodiments may be carried out in various different modes other than each of the above-described embodiments.

Constraint conditions can be applied to tasks for which it is desirable to set constraint conditions, in addition to tasks that cannot be achieved without proper settings of constraint conditions, such as a cup containing water or serving food. For example, in a case where an arm is moved with an edged tool such as scissors or a kitchen knife gripped and the edged tool is handed to a user, a loose constraint condition can be imposed so that a direction of a blade is kept away from the user. In addition, as a result of recognizing the environment, in a case where it is not desired to make much noise, a constraint condition (limitation) of a speed level of each joint is set, so that a task can be executed while the joint is moved quietly.

The constraint condition is not limited to an abstract concept of keeping an object horizontal, but it is also possible to set a specific numerical value such as the sound volume, speed, acceleration, or joint angle, degree of freedom of a robot, or the like. Furthermore, as the constraint condition, it is preferable to set a condition for an object to be gripped such as a cup, for example, to achieve a certain purpose, instead of a motion of the robot such as avoiding an obstacle. Note that a planned motion trajectory corresponds to a trajectory or the like of the arm or an end effector until the cup is put on a desk while the arm is moved with the obstacle avoided.

Furthermore, the learning method is not limited to the neural network, and other machine learning such as a support vector machine or a recurrent neural network can also be adopted. In addition, not only the supervised learning but also unsupervised learning, semi-supervised learning, or the like can be adopted. Furthermore, in each type of learning, it is also possible to use “the wind strength, the presence/absence of rain, a slope, a pavement status of a movement route”, or the like, which is an example of information on the environment in which the robot device 10 is placed. Moreover, these pieces of information on the environment can also be used to determine the constraint condition.

In addition, processing procedures, specific names, and information including various data and parameters illustrated in the above-described document and drawings can be arbitrarily changed unless otherwise specified. For example, various information illustrated in each drawing is not limited to the illustrated information.

Furthermore, each component of the illustrated devices is a functional concept, and does not necessarily have to be physically configured as illustrated in the drawings. That is, a specific form of distribution/integration of the devices is not limited to the one illustrated in the drawings, and all or part of the devices can be functionally or physically distributed/integrated in any unit according to various loads, a usage status, and the like. For example, a robot including an arm or the like and a control device including the robot control unit 30 that controls the robot and the control unit 40 can be implemented in separate housings. Furthermore, the learning of the constraint condition can be executed not by the constraint condition determination unit 43 but by a learning unit (not illustrated) or the like included in the control unit 40.

In addition, the above-described embodiments and modified examples can be appropriately combined as long as processing contents do not contradict each other.

Moreover, the effects described in the present specification are merely examples and are not limited, and there may be other effects.

### 4. Hardware Configuration

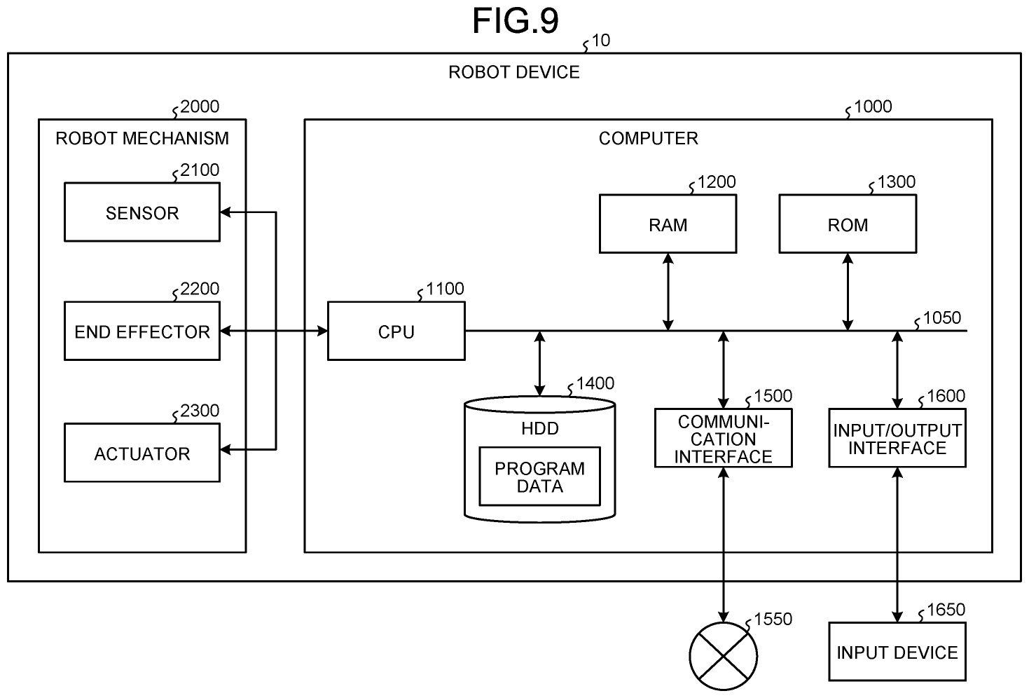

The robot device 10 according to each of the above-described embodiments can be implemented by, for example, a computer 1000 and a robot mechanism 2000 having configurations as illustrated in FIG. 9. FIG. 9 is a configuration diagram of hardware that implements functions of the robot device 10.

The computer 1000 includes a CPU 1100, a RAM 1200, a read only memory (ROM) 1300, an hard disk drive (HDD) 1400, a communication interface 1500, and an input/output interface 1600. Each unit of the computer 1000 is connected by a bus 1050.

The CPU 1100 operates based on programs stored in the ROM 1300 or the HDD 1400, and controls each unit. For example, the CPU 1100 expands the programs stored in the ROM 1300 or the HDD 1400 into the RAM 1200 and executes processing corresponding to various programs.

The ROM 1300 stores a boot program such as a basic input output system (BIOS) executed by the CPU 1100 when the computer 1000 is started, a program that depends on hardware of the computer 1000, and the like.

The HDD 1400 is a computer-readable recording medium that non-temporarily records the programs executed by the CPU 1100, data used by the programs, and the like. Specifically, the HDD 1400 is a recording medium that records a robot control program according to the present disclosure, which is an example of program data 1450.

The communication interface 1500 is an interface for the computer 1000 to connect to an external network 1550 (for example, the Internet). For example, the CPU 1100 receives data from another device and transmits data generated by the CPU 1100 to another device via the communication interface 1500.

The input/output interface 1600 is an interface for connecting an input/output device 1650 and the computer 1000. For example, the CPU 1100 receives data from an input device such as a keyboard or mouse via the input/output interface 1600. Furthermore, the CPU 1100 transmits data to an output device such as a display, a speaker, or a printer via the input/output interface 1600. Furthermore, the input/output interface 1600 may function as a media interface that reads a program or the like recorded on a predetermined recording medium (medium). The medium is, for example, an optical recording medium such as a digital versatile disc (DVD) or a phase change rewritable disk (PD), a magneto-optical recording medium such as a magneto-optical disk (MO), a tape medium, a magnetic recording medium, a semiconductor memory, or the like.

For example, in a case where the computer 1000 functions as the robot device 10 according to the first embodiment, the CPU 1100 of the computer 1000 executes the robot control program loaded on the RAM 1200 to implement functions of the robot control unit 30, the control unit 40, and the like. Furthermore, the HDD 1400 stores the robot control program according to the present disclosure and the data in each DB illustrated in FIG. 2. Note that the CPU 1100 reads the program data 1450 from the HDD 1400 to execute the program data 1450, but as another example, may acquire these programs from another device via the external network 1550.

The robot mechanism 2000 is a hardware configuration corresponding to the robot, includes a sensor 2100, an end effector 2200, and an actuator 2300, and these are connected to the CPU 1100 in a communicable manner. The sensor 2100 is various sensors such as a visual sensor, and acquires the object information of the object to be gripped and outputs the object information to the CPU 1100. The end effector 2200 grips the object to be gripped. The actuator 2300 drives the end effector 2200 and the like by instruction operation of the CPU 1100.

Note that the present technology can also have the following configurations.

(1)

A robot control device comprising:

an acquisition unit that acquires object information related to an object to be gripped by a robot device including a grip unit that grips an object; and

a determination unit that determines, based on operation contents executed by the robot device with the object gripped and the object information, a constraint condition when the operation contents are executed.

(2)

The robot control device according to (1), wherein

the determination unit determines, as the constraint condition, a condition for achieving a purpose imposed on the object when the operation contents are executed.

(3)

The robot control device according to (1) or (2), wherein

the determination unit decides whether or not the constraint condition is able to be determined from the operation contents, determines the constraint condition from the operation contents in a case where the constraint condition is able to be determined, and determines the constraint condition by use of the operation contents and the object information in a case where the constraint condition is not able to be determined.

(4)

The robot control device according to any one of (1) to (3), further comprising

a storage unit that stores constraint conditions associated with combinations of operation contents executed by the robot device and pieces of object information when the operation contents are executed, wherein

the determination unit determines the constraint condition from the storage unit based on a combination of the object information acquired by the acquisition unit and the operation contents executed with the object corresponding to the object information gripped.

(5)

The robot control device according to any one of (1) to (3), further comprising

a learning unit that learns a model by use of a plurality of pieces of teaching data in which operation contents and object information are set as input data and constraint conditions are set as correct answer information, wherein

the determination unit determines, as the constraint condition, a result obtained by inputting the operation contents and the object information to the learned model.

(6)

The robot control device according to any one of (1) to (3), further comprising

a learning unit that executes reinforcement learning by use of a plurality of pieces of learning data in which operation contents and object information are set as input data, wherein

the determination unit determines, as the constraint condition, a result obtained by inputting the operation contents and the object information to reinforcement learning results.

(7)

The robot control device according to any one of (1) to (6), wherein

the determination unit determines, as the constraint condition, a threshold value indicating a limit value of at least one of posture of the robot device, an angle of the grip unit, or an angle of an arm that drives the grip unit.

(8)

The robot control device according to any one of (1) to (7), wherein

the acquisition unit acquires image data obtained by capturing an image of a state in which the grip unit grips the object or a state before the grip unit grips the object.

(9)

A robot control method that executes processing of:

acquiring object information related to an object to be gripped by a robot device including a grip unit that grips an object; and

determining, based on operation contents executed by the robot device with the object gripped and the object information, a constraint condition when the operation contents are executed.

(10)

A robot control program that executes processing of:

acquiring object information related to an object to be gripped by a robot device including a grip unit that grips an object; and

determining, based on operation contents executed by the robot device with the object gripped and the object information, a constraint condition when the operation contents are executed.

### REFERENCE SIGNS LIST

10 ROBOT DEVICE
20 STORAGE UNIT
21 TASK DB
22 OBJECT INFORMATION DB
23 CONSTRAINT CONDITION DB
24 SET VALUE DB
30 ROBOT CONTROL UNIT
31 OBJECT INFORMATION ACQUISITION UNIT
32 GRIP UNIT
33 DRIVE UNIT
40 CONTROL UNIT
41 TASK MANAGEMENT UNIT
42 ACTION DETERMINATION UNIT
43 CONSTRAINT CONDITION DETERMINATION UNIT
44 PLANNING UNIT
45 ARM CONTROL UNIT

1. A robot control device comprising:
an acquisition unit that acquires object information related to an object to be gripped by a robot device including a grip unit that grips an object; and
a determination unit that determines, based on operation contents executed by the robot device with the object gripped and the object information, a constraint condition when the operation contents are executed.

2. The robot control device according to claim 1, wherein
the determination unit determines, as the constraint condition, a condition for achieving a purpose imposed on the object when the operation contents are executed.

3. The robot control device according to claim 1, wherein
the determination unit decides whether or not the constraint condition is able to be determined from the operation contents, determines the constraint condition from the operation contents in a case where the constraint condition is able to be determined, and determines the constraint condition by use of the operation contents and the object information in a case where the constraint condition is not able to be determined.

4. The robot control device according to claim 1, further comprising
a storage unit that stores constraint conditions associated with combinations of operation contents executed by the robot device and pieces of object information when the operation contents are executed, wherein
the determination unit determines the constraint condition from the storage unit based on a combination of the object information acquired by the acquisition unit and the operation contents executed with the object corresponding to the object information gripped.

5. The robot control device according to claim 1, further comprising
a learning unit that learns a model by use of a plurality of pieces of teaching data in which operation contents and object information are set as input data and constraint conditions are set as correct answer information, wherein
the determination unit determines, as the constraint condition, a result obtained by inputting the operation contents and the object information to the learned model.

6. The robot control device according to claim 1, further comprising
a learning unit that executes reinforcement learning by use of a plurality of pieces of learning data in which operation contents and object information are set as input data, wherein
the determination unit determines, as the constraint condition, a result obtained by inputting the operation contents and the object information to reinforcement learning results.

7. The robot control device according to claim 1, wherein
the determination unit determines, as the constraint condition, a threshold value indicating a limit value of at least one of posture of the robot device, an angle of the grip unit, or an angle of an arm that drives the grip unit.

8. The robot control device according to claim 1, wherein
the acquisition unit acquires image data obtained by capturing an image of a state in which the grip unit grips the object or a state before the grip unit grips the object.

9. A robot control method that executes processing of:
acquiring object information related to an object to be gripped by a robot device including a grip unit that grips an object; and
determining, based on operation contents executed by the robot device with the object gripped and the object information, a constraint condition when the operation contents are executed.

10. A robot control program that executes processing of:
acquiring object information related to an object to be gripped by a robot device including a grip unit that grips an object; and
determining, based on operation contents executed by the robot device with the object gripped and the object information, a constraint condition when the operation contents are executed.
